(19) United States
(12) Patent Application Publication
(10) Pub. No.: US 2008/0154869 A1
(43) Pub. Date: Jun. 26, 2008

(54) SYSTEM AND METHOD FOR CONSTRUCTING A SEARCH

(76) Inventor: Nicolas J.C. Leclercq, Heidelberg (DE)

Correspondence Address: KENYON & KENYON LLP, 1500 K STREET N.W., WASHINGTON, DC, 20005, US

(21) Appl. No.: 11/615,557

(22) Filed: Dec. 22, 2006

(51) Int. Cl. G06F 7/00

(52) U.S. Cl. 707/4

(57) ABSTRACT

Methods and systems are provided for constructing search expressions and executing searches based on user selection of a media item. A user may select an item by dragging the item to a search field. When a media item has been selected, a search expression is constructed based on text or metadata associated with the media item. The search expression may be constructed based on rules defined in the system, which can allow for consistent behavior in within an application or between multiple applications.

### BACKGROUND

Many computer systems and applications include some search functionality. For example, operating systems typically provide an that allow a user to search files stored on a computer. Individual applications, such as word processing programs or image manipulation programs, may also provide limited search functionality such as searching for a specific word in a document or a specific image in a photo library. Network applications, such as interactive web pages, may also provide search functionality, such as an input area that allows a user to search all the pages in a website for a specific word or phrase.

Typically, a user will enter the search term or terms for which a search is desired by typing them in to a search field. For example, an operating system may provide a search application that presents an input area. When the user types a search term into the input area, the application searches the files stored on the computer for those having filenames which match the search term. Similarly, a website may provide a search bar at the top of every page. When a user types a search term into the search bar, the remote server may perform a search of the web pages that make up the website and provide a list of matching pages to the user. These sorts of search systems may result in inaccurate or un-matched search expressions due to typographical or transcription errors made by a user. For example, a user may intend to type a term appearing on a web page into the search bar with the intent of finding other pages in a website that share the term. If the user types the term inaccurately, the search results may be inaccurate, and the user may be unable to find information that could be provided by a more accurate search.

In some cases, a user may be able to provide a search term in ways other than typing the term directly into a search box. For example, some applications allow a user to highlight text in the application and “drag” the text to a search field, such as by using a mouse to control an on-screen pointer. A copy of the highlighted text is entered into the search field by the application, which may reduce user error in transcribing text. For other items, such as hyperlinks or pictures, an application may insert the target of the hyperlink or location of the picture. In some cases, the text to which the hyperlink is attached or the filename of the picture's image file also may be used.

Although different input methods are provided by applications, the associated behavior may be inconsistent. For example, a web browser application may copy the text associated with a hyperlink when the hyperlink is selected and dragged to a search field, while a web page displayed in the browser may copy the location to which the hyperlink points. In addition, this extended functionality generally is not available between different applications. For example, a user typically cannot highlight text or an image in one application and drag it into a search field in a separate application. Most applications that provide this functionality also restrict it to use with text and/or images, and do not allow searches based on other media types such as video files, animation, audio files, or combinations of these types. These inconsistencies may result in user confusion. For example, a user may expect that when an image is dragged to a search field, the “tooltip” or “hover” text (i.e., the text displayed when a pointer is placed over the image, such as a title) will be placed in the search field. However, the application may instead use the filename of the image, the URL of the image, or other information, and the same information may not be used by each application that displays images.

### BRIEF DESCRIPTION OF THE DRAWINGS

FIG. 1 shows construction of a search expression according to an embodiment of the present invention.

FIG. 2 shows construction of a search expression according to an embodiment of the present invention.

FIG. 3 shows construction of a search expression according to an embodiment of the present invention.

FIG. 4 shows a method of constructing a search expression according to an embodiment of the present invention.

### DETAILED DESCRIPTION

Systems and methods are provided that allow a user to construct a search expression based on an arbitrary media item type. In an embodiment, the user may select an item for which a search is desired and “drag” the item to a search field in an application. The search field may be in the same application as the search item, or it may be in a separate application. A search item also may be selected in other ways, such as via a context-sensitive menu. When the user selects a search item, a search expression may be constructed based on the type of the item or metadata associated with the item. The search expression may be constructed based on rules specific to the search item, the search item type, the application displaying the item, and/or user-defined criteria. A search may be executed automatically using the constructed search expression without further input from the user.

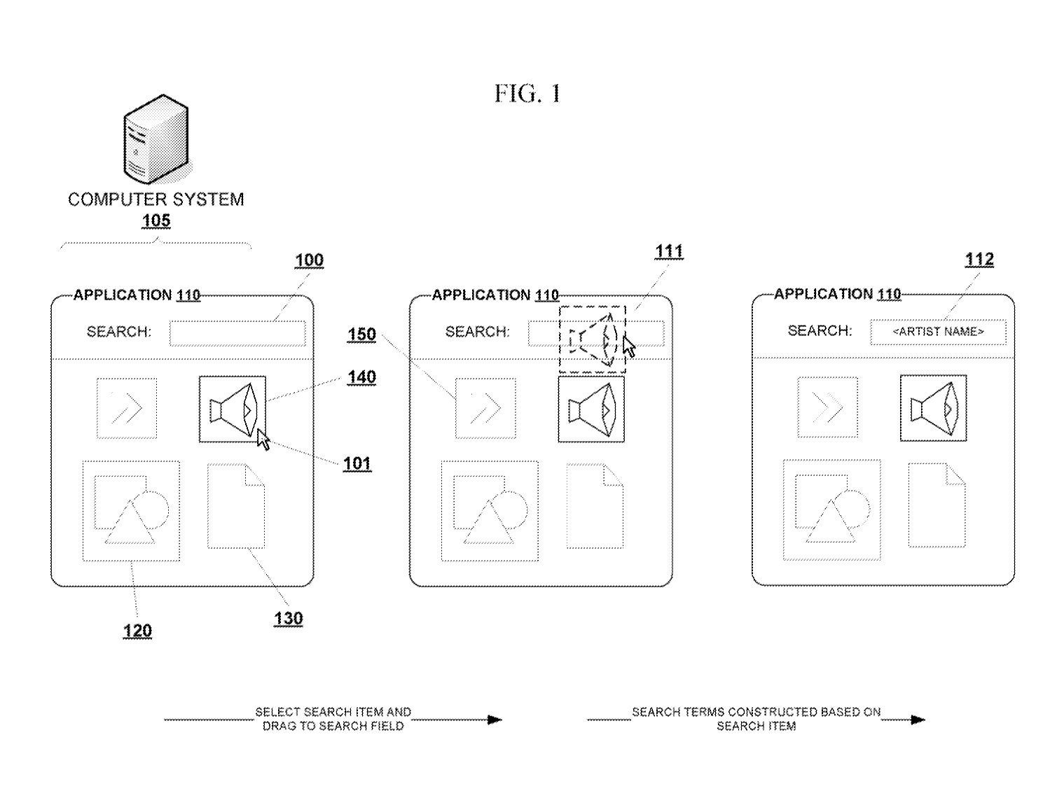

FIG. 1 shows construction of a search expression according to an embodiment of the present invention. A computer system 105 may store and execute one or more applications 110. The system may be implemented on one or more computers, which may be in communication with each other and/or a user terminal such as a personal computer via a network. Unless specified otherwise herein, the specific arrangement of computers, servers and terminals and any associated network architecture is irrelevant to the present invention. An application 110 may display various media items, including images 120, text 130, audio 140, and video 150. Other items, such as animations and links, may also be displayed. In some cases a link may be considered a text-type item, such as a text-based hyperlink in a web page, or it may be another media type, such as an interface element in an application.

For example, the application 110 may be a web page or a web browser displaying a page that includes the items 110-150, or any other type of application. The application may include a search field 100 into which a user may enter a search expression. The search field 100 may be part of the application 110, or it may be provided, for example, by the operating system that executes and/or manages the application 110. A user may select a media item from which a search expression is to be constructed, such as the audio media item 140. For example, the user may indicate that the audio media item 140 is to be used to construct the search expression by using a pointer 101 to select and move the item or a representation of the item to the search field.

Such “click and drag” functionality is often used in windowed operating systems and other user interfaces, as will be understood by one of skill in the art. However, in typical systems this functionality is used to move files, arrange icons, or perform similar tasks. In embodiments of the present invention, it may be used to indicate an item from which the user desires a search expression to be constructed. For example, as shown in FIG. 1 a user may select and drag an audio item 140 to the search field 100. To indicate the operation taking place, a representation such as a semi-transparent image 111 of the selected media item may be displayed.

Once the user has selected the item 140, application 110, the underlying operating system, or another application may construct a search expression 112 based on the item 140. The contents of the search expression may be determined from the type of item selected. For example, if the selected item 140 is a song embedded in the application, the search expression may include the name of the artist performing the song, as shown in FIG. 1. The search expression may also be constructed based on the specific content of the item, and/or from metadata associated with the item. For example, a displayed item may have “tooltip” text associated with it, i.e., text that is displayed when the pointer 101 is placed over the item for a short period of time. Often such text is descriptive of the item, such as the title of a photograph. In an embodiment, this text may be used as the search expression, or used to construct the search expression. Each displayed item also may have other metadata associated with it, which may or may not be displayed to or accessible by the user. In an embodiment, this metadata may be used to construct the search expression.

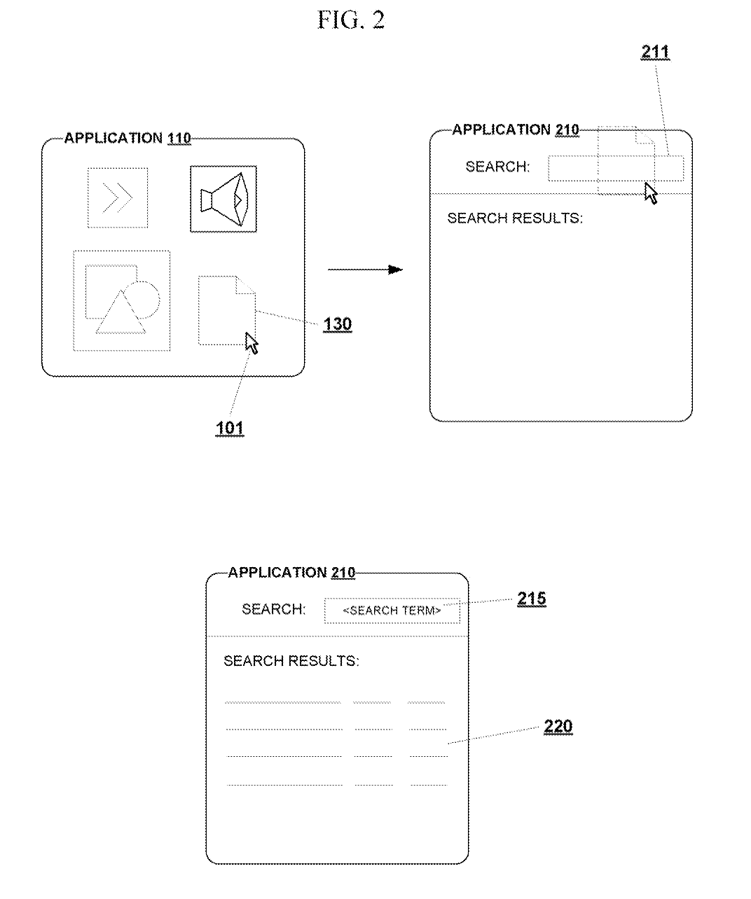

Items displayed in a first application may also be used to construct a search expression in another application. For example, an operating system may provide a general search application. In an embodiment of the present invention, a search application may use items selected from other applications to construct a search expression. Referring to FIG. 2, a first application 110 may display various media items as previously described. A user may select and drag one of the media items to a second application 210 that includes a search field 211. For example, a user can highlight text 130 in the first application 110 and drag the highlighted text to the second application 210, where a search expression may be constructed based on the text. As previously described, the search expression may also be constructed based on tooltip text or other metadata associated with the selection.

In an embodiment, a search expression may be constructed based on a combination of media items. For example, a user may select multiple media items, such as an image and surrounding text, and drag the combined items to a search field. A search expression may then be constructed by applying rules defined for each of the selected item types. In some cases, additional rules may be defined that determine how the search expressions for each item should be combined to create a single search expression.

In an embodiment, the search may be run automatically, i.e., without further user input, after the user selects the search item. For example, the application 210 may construct a search expression 215 based on the item selected by the user, execute a search using the expression, and present search results 220 to the user without requiring additional user input.

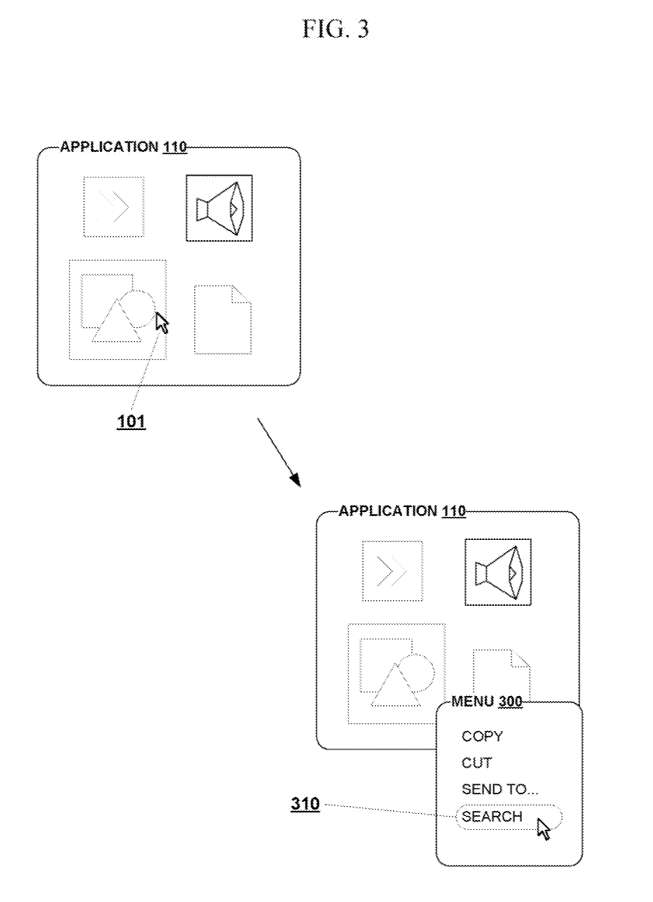

FIG. 3 shows a search expression constructed according to an embodiment of the invention. As previously described, an application 110 may display various media items such as text, audio, video, etc. A user may activate a context-sensitive menu 310, such as by positioning a pointer on a desired item and using an auxiliary input such as a second mouse button to activate the context-sensitive menu. If the item is one from which the application 110 may construct a search expression, a “search” option may be presented in the context-sensitive menu 310. A search expression may then be constructed and a search performed as previously described.

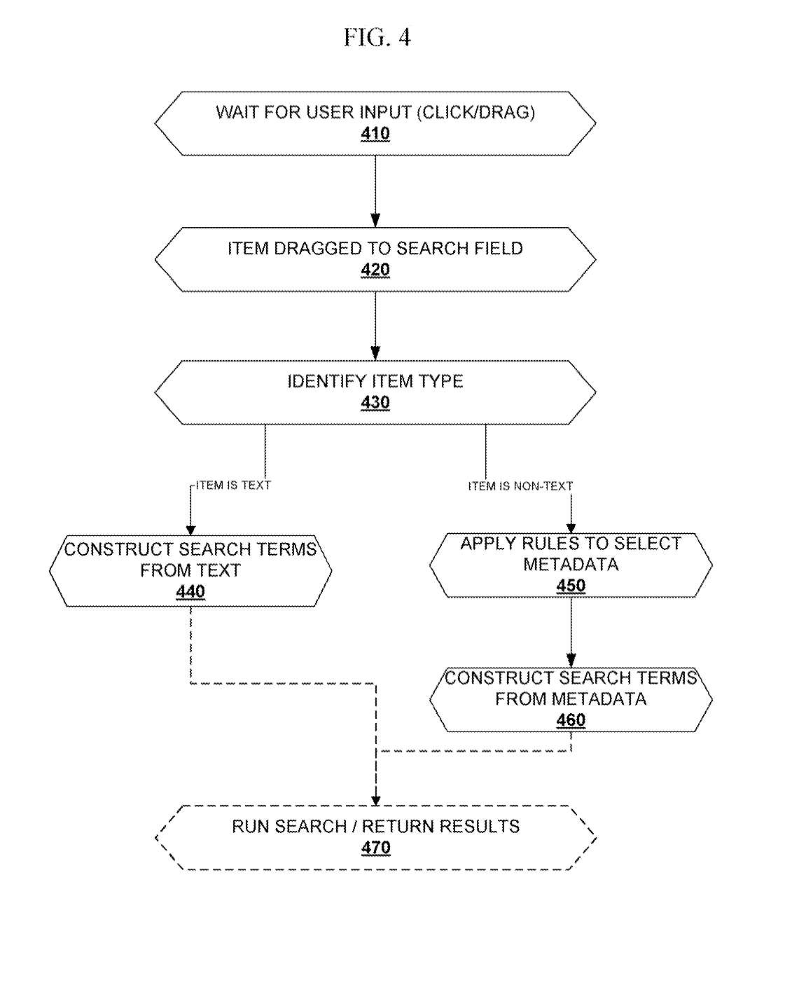

FIG. 4 shows a method for constructing a search expression according to the invention. One or more applications or systems may wait for appropriate user input 410, such as an item being selected and dragged to a search field 420. When an item is selected, the item type may be identified 430. For example, in an embodiment different rules may be applied to each item type such as video, audio, image, animation, text, etc. If the selected item is text or a text-related media item, the search expression may be directly constructed from the text 440. For example, if a small amount of text was selected by the user, the search expression may include each selected word. Other rules may be applied, including various logical operators such as AND, OR, NOT, etc. If the selected item is non-text, rules may be applied to select appropriate metadata associated with the item 450. For example, if the selected item is a graphical type (video, animation, image, etc.), a title or descriptive phrase may be used. Other metadata, such as the creator of the item, a relevant file type, or a storage location may also be used. Once the appropriate metadata is identified, additional rules may be applied to construct a search expression 460. The rules applied in selecting metadata and constructing search terms may be uniform within the application or operating system constructing the search expression. The rules may be pre-defined, such as by a developer or programmer of the application, or the system may allow for the creation of various rules by a user. For example, the default rule may specify that metadata associated with a selected item is to be added to a search expression using the boolean AND operator, as is generally the case when separate terms are entered into a search field. As a specific example, an audio element may have metadata that identifies the artist as “John Doe” and the title as “My Song.” When the audio element is selected, the search expression “‘Cohn Doe’ AND ‘My Song’ ” may be constructed.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for constructing a search expression, comprising:
responsive to a user selecting a search item, identifying the item type;
if the item contains text, constructing a search expression having at least one term in common with the text; and
if the selected item does not contain text, identifying metadata associated with the selected item and constructing a search expression based on the metadata.

2. The method of claim 1, wherein the selecting a search item comprises selecting an item displayed in an application and positioning a representation of the item in a search field.

3. The method of claim 1, wherein the selecting a search item comprises activating a context-sensitive menu item.

4. The method of claim 1, further comprising executing a search based on the search expression without receiving additional user input.

5. The method of claim 4, wherein the search item is displayed in a first application, and the search is performed in a second application.

6. The method of claim 1, wherein the search item is one of a plurality of items displayed in a first application, and the user selecting the search item comprises dragging the search item to a second application.

7. The method of claim 1, wherein constructing a search expression based on the metadata comprises applying rules based on the search item type.

8. The method of claim 7, wherein the rules are the same for each application executed by an operating system.

9. The method of claim 1, wherein the search item is one of a link, an image, an audio item, or a video item.

10. A search method comprising, responsive to a drag and drop operation performed on a system object:
placing the object in a search window;
identifying metadata associated with the system object; and
building a search expression from the metadata.

11. The method of claim 10, further comprising executing a search based on the search expression without receiving additional user input.

12. The method of claim 10, wherein the drag and drop operation comprises dragging the system object from a first application to a second application.

13. The method of claim 10, wherein the search expression is based on rules specific to the type of the system object.

14. The method of claim 13, wherein the rules are defined by a user of the system prior to performing the drag and drop operation.

15. A system comprising:
a storage medium to store media items and metadata;
a user interface to receive user input and display one or more of the media items;
a processor to execute one or more applications;
a first application to provide one or more of the media items to the user interface; and
a second application to construct a search expression based on a user selection of one of the one or more media items displayed by the user interface;
wherein the search expression is constructed based on metadata associated with a media item selected by a user.
